(19) United States
(12) Patent Application Publication
(10) Pub. No.: US 2025/0353205 A1
(43) Pub. Date: Nov. 20, 2025

(54) FOOD PRODUCT SLICER WITH REMOVABLE MEAT GRIP ASSEMBLY SLIDE ROD

(71) Applicant: ILLINOIS TOOL WORKS INC., Glenview, IL (US)

(72) Inventors: Matthew W. BIRD, Xenia, OH (US); Curtis SMITH, Troy, OH (US)

(21) Appl. No.: 19/192,705

(22) Filed: Apr. 29, 2025

Related U.S. Application Data
(60) Provisional application No. 63/647,301, filed on May 14, 2024.

(51) Int. Cl. B26D 7/06

(52) U.S. Cl. CPC B26D 7/0616; B26D 2210/02

(57) ABSTRACT

A food product slicer includes a base, a knife mounted for rotation relative to the base, a carriage assembly mounted to the base for reciprocal movement back and forth past a cutting edge of the knife, wherein the carriage includes a tray for holding food product during slicing, and a movable gauge plate for varying a thickness of food product slices. A slide rod is releasably connected to the carriage assembly, and a meat grip assembly is mounted on the slide rod so as to be movable along at least a portion of a length of the slide rod. The slide rod is releasably retained to the carriage assembly by a magnetic retention force to allow for removal of the slide rod for cleaning.

### TECHNICAL FIELD

This application relates generally to food product slicers of the type commonly used to slice bulk food products and, more specifically, to a mount arrangement of a meat grip assembly in such a food product slicer.

### BACKGROUND

Typical reciprocating food slicers have a rotatable, circular or disc-like slicing blade, an adjustable gauge plate for varying the thickness of the slice and a carriage for supporting the food as it is moved back and forth past the cutting edge of the knife during slicing. A drive motor may be linked to drive the carriage back and forth during an automatic slicing operation carried out by a controller of the slicer. The gauge plate is situated along the edge of the knife toward the front of a slicing stroke and is laterally movable with respect to the knife for varying the thickness of the slices to be cut. A rotatable adjustment or indexing knob is provided manually for setting a spacing between the plane of the gauge plate surface and the plane of the knife edge for the purpose of slicing so that operators can select a thickness of slices to be produced.

Typical slicers either have a threaded rod or permanently attached meat grip assembly slide rod. The slicers that permanently attach the slide rod generally remove a smaller portion of the meat grip to satisfy cleanability requirements.

U.S. Patent Publication No. 2012/0266731 describes a removable slide rod. In two embodiments, a spring-biased pin is used to releasably retain the slide rod in place. In a third embodiment, a flexing retention clip is used to releasably hold the slide rod in place. In a fourth embodiment, the slide rod is threadedly attached. These embodiments add complexity and cost to the manufacturing process and/or create some difficulty with slide rod removal and installation.

Accordingly, it would be desirable to provide a slicer with an improved meat grip assembly slid rod mounting system that is simpler and/or more ergonomic in terms of slide rod removal and installation.

### SUMMARY

In one aspect, a food product slicer includes a base, a knife mounted for rotation relative to the base, a carriage assembly mounted to the base for reciprocal movement back and forth past a cutting edge of the knife, wherein the carriage includes a tray for holding food product during slicing, and a movable gauge plate for varying a thickness of food product slices. A slide rod is releasably connected to the carriage assembly, and a meat grip assembly is mounted on the slide rod so as to be movable along at least a portion of a length of the slide rod. The slide rod is releasably retained to the carriage assembly by a magnetic retention force to allow for removal of the slide rod for cleaning.

In another aspect, a method is provided for utilizing a slide rod of a food product slicer carriage assembly, wherein a meat grip is mounted for movement along at least a portion of the slide rod. The method involves: retaining the slide rod in an operating position on the carriage assembly via a magnetic retention force; and moving the slide rod out of the operating position by gripping a portion of the slide rod and pulling the slide rod with a removal force that overcomes the magnetic retention force.

In another aspect, a food product slicer, includes a base; a knife mounted for rotation relative to the base; a carriage assembly mounted to the base for reciprocal movement back and forth past a cutting edge of the knife, wherein the carriage includes a tray; a movable gauge plate for varying a thickness of food product slices; a slide rod releasably connected to the tray; and a meat grip assembly mounted on the slide rod. The slide rod is releasably retained to the tray by magnetic force to allow for simple removal of the slide rod for cleaning.

The details of one or more embodiments are set forth in the accompanying drawings and the description below. Other features, objects, and advantages will be apparent from the description and drawings, and from the claims.

### BRIEF DESCRIPTION OF DRAWINGS

FIGS. 1 and 2 show a food product slicer; and

FIGS. 3-8 show the tray and meat grip assembly or portions thereof.

### DETAILED DESCRIPTION

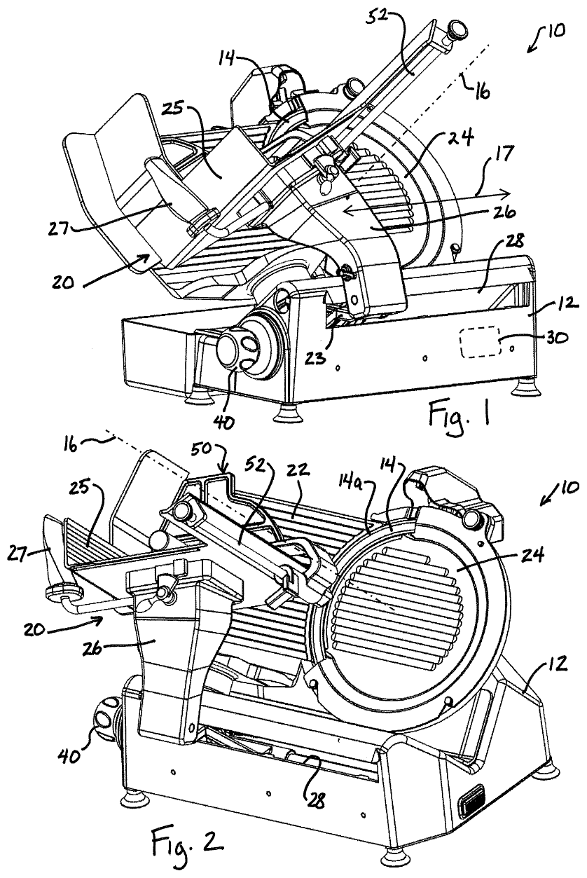

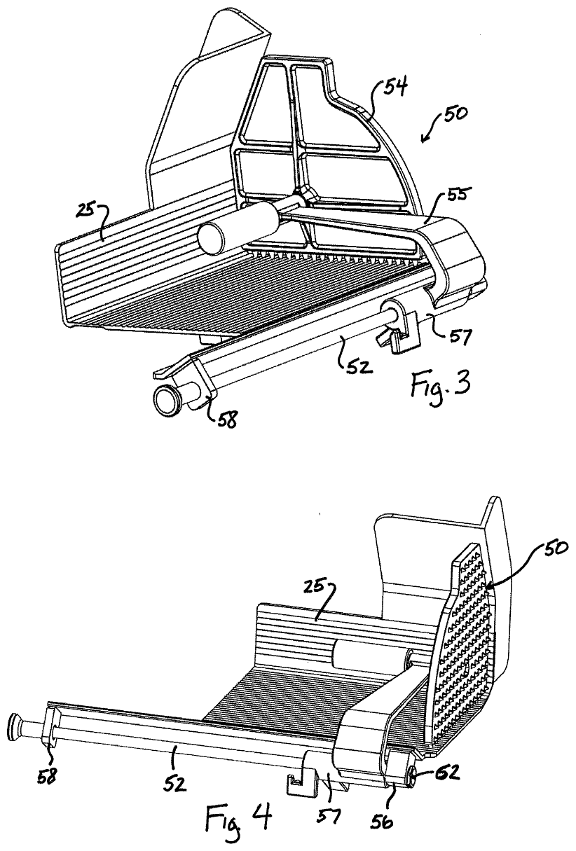

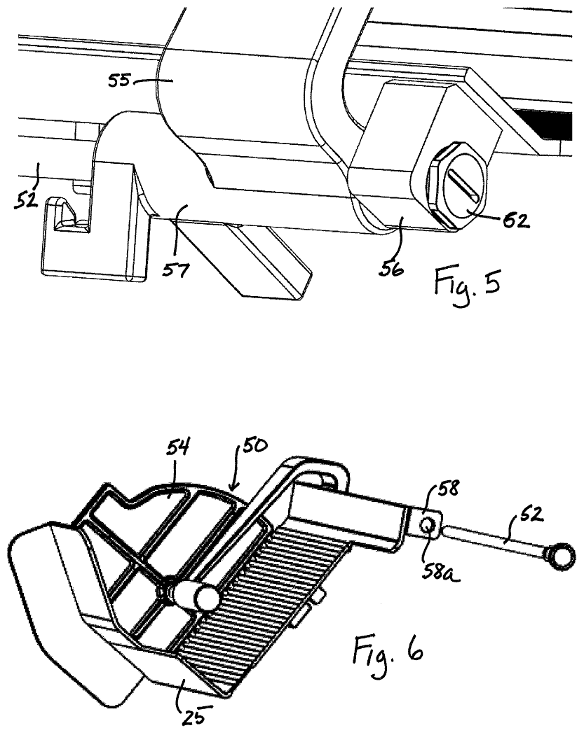

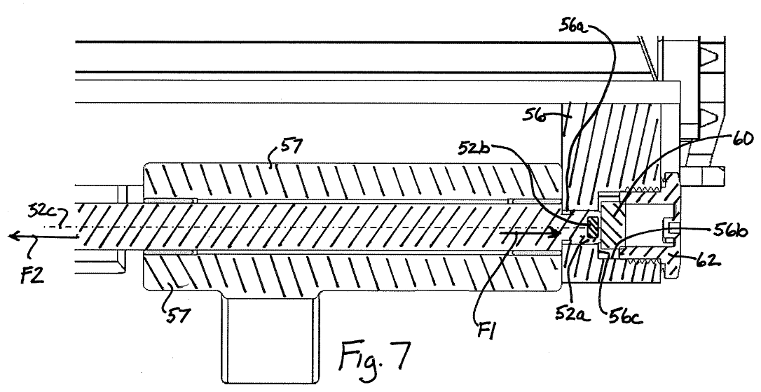

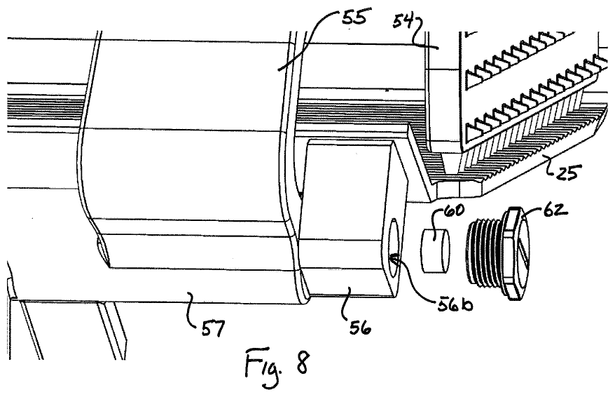

Referring to FIGS. 1-8, a food product slicer 10 includes a base 12 (e.g., housing and/or frame) and a circular, motor-driven slicing knife 14 that is mounted to the housing for rotation about an axis 16. The left side of FIG. 1, where the controls are located, is generally referred to as the front side of the slicer (which is where an operator stands for slicing), the right side of FIG. 1 is generally referred to as the rear side of the slicer. A food product can be supported on a manually operable (or motor driven) food carriage 20 which moves the food product to be sliced past the cutting edge 14a of the rotating slicing knife 14. The food carriage 20 reciprocates back and forth along a linear path 17 so that the lower end of the bulk food product slides along the surface of a gauge plate 22, is cut by the knife 14 and then slides along a knife cover plate 24. The food carriage 20 includes a tray 25 mounted on a tray arm 26 that is mounted on a transport 23 and that orients the food carriage tray at the appropriate angle (typically perpendicular) to the knife cutting-edge plane. The food carriage arm reciprocates along a slot 28 at a lower portion of the housing 12. The carriage 20 can be moved manually (e.g., by a handle 27) and/or the carriage 20 may also be automatically driven (e.g., as by an internal motor 30 that drives a belt that is linked internally to a transport to which the arm 26 is pivotably connected). A gauge plate system includes a rotatable knob 40 (connected to an opening in the base 12).

A meat grip assembly 50 is mounted on a slide rod 52 and can move both axially along the length of the slide rod 52 and pivotably about the slide rod 52, so as to accommodate different lengths of food product sitting on the tray 25. Generally, a pusher plate 54 of the meat grip assembly sits against the outwardly facing end of the food product chub to apply some force against the food product to urge the food product down along the tray surface toward the gauge plate 22. A mount arm 55 extends to a tubular mount 57 that is disposed about the slide rod. The slide rod 52 is mounted to the tray 25 by a mount bracket 56 connected to the tray and a stabilizing bracket 58 connected to the tray. The stabilizing bracket 58 includes a through opening 58a through which the slide rod 52 extends such that the connection end of the slide rod engages into the mount bracket 56. The connection end of the slide rod 52 includes a reduced diameter head part 52a that fits into a hole 56a of the mount bracket 56 for this purpose. A magnet 60 is disposed in or on the bracket 56 so as to magnetically interact with the head part 52a and releasably retain the slide rod in place with an axial magnetic retention force F1 in a direction along the axis 52c of the slide rod. The slide rod may be manufactured of a magnetic stainless steel (e.g. 400 series) for this purpose. To remove the slide rod 52 from the tray, a machine operator simply pulls axially on the slide rod to apply an axial removal force F2 that is in an opposite direction to force F1 and that is sufficient to overcome the magnetic retention force F1.

In embodiments, the axial magnetic retention force F1 is between about 35 and 75 Newtons (e.g., between about 45 and 65 Newtons). However, variations are possible.

Here, the magnet 60 is retained in a cavity 56b of the mount bracket 56 by a threaded plug 62. The diameter of the cavity 56b is larger than the diameter of opening 56b, which creates an internal shoulder 56c that is sized to prevent passage of the magnet 60 through the opening 56a. In embodiments, this configuration provides for simple assembly/production and also allows the magnet 60 to be easily removed from the bracket 56 by removing the plug 62. In an alternative arrangement, the magnet 60 could be fixed in or on the mount bracket 56 or fixed in or on the threaded plug 62.

In an alternative embodiment, the slide rod 52 could be made out of 300 series stainless steel (which is non-magnetic), and the head part 52a of the slide could include a magnetic insert (e.g., 52b) to magnetically interface/interact with the magnet 60. In other embodiments, the sole magnet present could be the magnetic insert 52b of the head part, with the mount bracket 56, or portions thereof, being made of a magnetic stainless steel.

The above attachment system provides one or more advantages such as being (i) simple and easy to use—this slide rod attachment method should make cleaning and slicer breakdown easier and quicker and/or (ii) easy-to-remove, which should make operators more willing to remove and properly clean/sanitize these parts and/or (iii) operating as a quick-release for the slide rod.

The above attachment system provides a method of utilizing a slide rod of a food product slicer carriage assembly, wherein a meat grip is mounted for movement along at least a portion of the slide rod. The method involves: retaining the slide rod in an operating position on the carriage assembly via a magnetic retention force; and moving the slide rod out of the operating position by gripping a portion of the slide rod and pulling the slide rod with a removal force that overcomes the magnetic retention force. In implementations, the magnetic retention force is an axial magnetic retention force that operates in a first direction along an axis of the slide rod, and the removal force operates in a second direction along the axis of the slide rod, the second direction being opposite the first direction. In implementations, the axial magnetic retention force is between about thirty-five and seventy-five Newtons.

It is to be clearly understood that the above description is intended by way of illustration and example only and is not intended to be taken by way of limitation. Variations are possible.

1. A food product slicer, comprising:
a base;
a knife mounted for rotation relative to the base;
a carriage assembly mounted to the base for reciprocal movement back and forth past a cutting edge of the knife, wherein the carriage includes a tray for holding food product during slicing;
a movable gauge plate for varying a thickness of food product slices;
a slide rod releasably connected to the carriage assembly;
a meat grip assembly mounted on the slide rod so as to be movable along at least a portion of a length of the slide rod;
wherein the slide rod is releasably retained to the carriage assembly by a magnetic retention force to allow for removal of the slide rod for cleaning.

2. The food product slicer of claim 1, wherein the tray includes a mount bracket with an opening into which an end part of the slide rod engages, and a magnet is associated with the mount bracket for producing the magnetic retention force.

3. The food product slicer of claim 2, wherein the magnet is located in a cavity of the mount bracket and a threaded plug retains the magnet in the cavity.

4. The food product slicer of claim 2, wherein the end part of the slide rod is of a magnetic material to interact with the magnet.

5. The food product slicer of claim 2, wherein the end part of the slide rod comprises a magnet to interact with the magnet of the mount bracket.

6. The food product slicer of claim 1, wherein the end part of the slide rod comprises a magnet that magnetically interacts with at least a portion of the mount bracket.

7. The food product slicer of claim 1, wherein the magnetic retention force is an axial magnetic retention force along an axis of the slide rod.

8. The food product slicer of claim 7, wherein the axial magnetic retention force is between about thirty-five and seventy-five Newtons.

9. The food product slicer of claim 7, wherein removal of the slide rod is possible solely by pulling along the axis of the slide rod with an axial removal force that is greater than the axial magnetic retention force.

10. A method of utilizing a slide rod of a food product slicer carriage assembly, wherein a meat grip is mounted for movement along at least a portion of the slide rod, the method comprising:
retaining the slide rod in an operating position on the carriage assembly via a magnetic retention force; and
moving the slide rod out of the operating position by gripping a portion of the slide rod and pulling the slide rod with a removal force that overcomes the magnetic retention force.

11. The method of claim 10, wherein the magnetic retention force is an axial magnetic retention force that operates in a first direction along an axis of the slide rod, and the removal force operates in a second direction along the axis of the slide rod, the second direction being opposite the first direction.

12. The method of claim 10, wherein the axial magnetic retention force is between about thirty-five and seventy-five Newtons.

13. The method of claim 10,
wherein the carriage assembly includes a mount bracket with an opening into which an end part of the slide rod engages;
wherein a magnet is associated with the mount bracket for producing the magnetic retention force;
wherein:
the magnet is located in a cavity of the mount bracket and a threaded plug retains the magnet in the cavity;
and/or
the end part of the slide rod is of a magnetic material to interact with the magnet;
and/or
the end part of the slide rod comprises a magnet to interact with the magnet of the mount bracket.

14. The method of claim 10,
wherein the carriage assembly includes a mount bracket that is engaged by an end part of the slide rod;
wherein the end part of the slide rod comprises a magnet that magnetically interacts with at least a portion of the mount bracket;
wherein:
the mount bracket carries a magnet;
and/or
at least part of the mount bracket comprises a magnetic material.
